(19) United States
(12) Patent Application Publication
(10) Pub. No.: US 2014/0084859 A1
(43) Pub. Date: Mar. 27, 2014

(54) Vehicle Charger Safety System and Method

(71) Applicant: WiTricity Corporation, Watertown, MA (US)

(72) Inventors: Katherine L. Hall, Westford, MA (US); Morris P. Kesler, Bedford, MA (US); Ron Fiorello, Tewksbury, MA (US); David A. Schatz, Needham, MA (US); Konrad J. Kulikowski, Somerville, MA (US); Marin Soljacic, Belmont, MA (US)

(73) Assignee: WiTricity Corporation, Watertown, MA (US)

(21) Appl. No.: 14/087,512

(22) Filed: Nov. 22, 2013

Related U.S. Application Data
(62) Division of application No. 12/899,281, filed on Oct. 6, 2010.
Application No. 12/899,281 is a continuation-in-part of application No. 12/613,686, filed on Nov. 6, 2009, now Pat. No. 8,035,255.
Application No. 12/613,686 is a continuation of application No. 12/567,716, filed on Sep. 25, 2009, now Pat. No. 8,461,719.
Application No. 12/899,281 is a continuation-in-part of application No. 12/721,118, filed on Mar. 10, 2010.
Application No. 12/721,118 is a continuation-in-part of application No. 12/705,582, filed on Feb. 13, 2010, now abandoned.
Application No. 12/899,281 is a continuation-in-part of application No. 12/770,137, filed on Apr. 29, 2010.
Application No. 12/770,137 is a continuation-in-part of application No. 12/767,633, filed on Apr. 26, 2010, now Pat. No. 8,497,601.
(60) Provisional application No. 61/178,508, filed on May 15, 2009.
(60) Provisional application No. 61/182,768, filed on Jun. 1, 2009.
(60) Provisional application No. 61/172,633, filed on Apr. 24, 2009.
(60) Provisional application No. 61/173,747, filed on Apr. 29, 2009.

(51) Int. Cl. B60L 11/18; H02J 7/02

(52) U.S. Cl. CPC B60L 11/182; H02J 7/025
USPC 320/108

(57) ABSTRACT

Wireless vehicle charger safety systems and methods use a detection subsystem, a notification subsystem and a management subsystem. The detection subsystem identifies a safety condition. The notification subsystem provides an indication of the safety condition. The management subsystem addresses the safety condition. In particular, undesirable thermal conditions caused by foreign objects between a source resonator and a vehicle resonator are addressed by sensing high temperatures, providing a warning and powering down a vehicle charger, as appropriate for the environment in which the charger is deployed.

### CROSS-REFERENCE TO RELATED APPLICATIONS

This application is a division of co-pending U.S. application Ser. No. 12/899,281, filed Oct. 6, 2010, which is incorporated by reference in its entirety.

This application is a continuation-in-part and claims the benefit of the following commonly owned U.S. patent applications, the contents of which are incorporated herein by reference: copending U.S. patent application Ser. No. 12/613,686 published on May 6, 2010 as US 2010010909445 and entitled “Wireless Energy Transfer Systems,” which is a continuation of copending U.S. patent application Ser. No. 12/567,716 published on Jun. 10, 2010 as US 20100141042 and entitled “Wireless Energy Transfer Systems;” U.S. patent application Ser. No. 12/721,118, filed Mar. 10, 2010 and published on Sep. 16, 2010 as US 20100231340 and entitled “Wireless Energy Resonator Enclosures,” which is a continuation-in-part of U.S. patent application Ser. No. 12/705,582, filed Feb. 13, 2010; and U.S. patent application Ser. No. 12/770,137, filed Apr. 29, 2010 and published on Nov. 4, 2010 as US 20100277121 and entitled “Wireless Energy Transfer Between a Source and a Vehicle,” which is a continuation-in-part of U.S. patent application Ser. No. 12/767,633 filed Apr. 26, 2010. These applications claim the benefit of provisional application No. 61/100,721, filed on Sep. 27, 2008, provisional application No. 61/108,743, filed on Oct. 27, 2008, provisional application No. 61/147,386, filed on Jan. 26, 2009, provisional application No. 61/152,086, filed on Feb. 12, 2009, provisional application No. 61/178,508, filed on May 15, 2009, provisional application No. 61/182,768, filed on Jun. 1, 2009, provisional application No. 61/121,159, filed on Dec. 9, 2008, provisional application No. 61/142,977, filed on Jan. 7, 2009, provisional application No. 61/142,885, filed on Jan. 6, 2009, provisional application No. 61/142,796, filed on Jan. 6, 2009, provisional application No. 61/142,889, filed on Jan. 6, 2009, provisional application No. 61/142,880, filed on Jan. 6, 2009, provisional application No. 61/142,818, filed on Jan. 6, 2009, provisional application No. 61/142,887, filed on Jan. 6, 2009, provisional application No. 61/156,764, filed on Mar. 2, 2009, provisional application No. 61/143,058, filed on Jan. 7, 2009, provisional application No. 61/152,390, filed on Feb. 13, 2009, provisional application No. 61/163,695, filed on Mar. 26, 2009, provisional application No. 61/172,633, filed on Apr. 24, 2009, provisional application No. 61/169,240, filed on Apr. 14, 2009, and provisional application No. 61/173,747, filed on Apr. 29, 2009.

Application Ser. No. 12/705,582 is a continuation-in-part of the following U.S. patent application Ser. No. 12/639,489 filed Dec. 16, 2009 and Ser. No. 12/647,705, filed Dec. 28, 2009. Application Ser. No. 12/767,633 is a continuation-in-part of U.S. patent application Ser. No. 12/757,716 filed Apr. 9, 2010, which is a continuation-in-part of U.S. patent application Ser. No. 12/749,571 filed Mar. 30, 2010, which is a continuation-in-part of the following U.S. patent application Ser. No. 12/639,489 filed Dec. 16, 2009 and Ser. No. 12/647,705, filed Dec. 28, 2009.

### BACKGROUND

1. Field

This disclosure relates to charging vehicles using wireless energy transfer and apparatus to accomplish such charging.

2. Description of the Related Art

Energy or power may be transferred wirelessly using a variety of known radiative, or far-field, and non-radiative, or near-field, techniques as detailed, for example, in commonly owned U.S. patent application Ser. No. 12/613,686 published on May 6, 2010 as US 2010010909445 and entitled “Wireless Energy Transfer Systems,” the contents of which is incorporated by reference. To date, use of wireless systems for vehicle charging, such as in charging stations for fully electric or hybrid automobiles, has been limited due to various difficulties. For instance, efficiency in energy transfer, physical proximity/alignment of supply and device components and related factors have all posed challenges limiting commercial deployment of wireless vehicle charging apparatus.

The amount of energy that needs to be transferred when charging an electric vehicle is significant and to do so in a reasonable timeframe requires significant levels of power transfer. For wired charging systems, numerous safety issues need to be considered, such as cut cables, abraded insulation, sparking connectors in areas with potentially flammable materials, heat build-up from connections that are dirty or have otherwise developed up some electrical resistance, cable breakaways due to operator failure to set parking brakes, etc. Wireless charging systems as described in the patent documents incorporated by reference can operate at transfer rates appropriate for vehicle charging. Although these systems obviate many of the safety concerns of wired vehicle charging systems, some safety issues still remain and they may be quite different than those in either wired vehicle charger systems or in smaller wireless systems, such as those used to charge consumer devices (e.g., cell phones and laptop computers).

One particular area of concern with vehicle charging is the potential overheating of materials in the area of the charging system. For example, a metal object between a vehicle charger's source resonator and an automobile's device resonator may become too hot to touch as a result of eddy currents that are induced in the object. Such a heated object could be in a location where someone might step on it or pick it up. A wrench left on a garage floor under a charging automobile could remain hot to the touch even after the automobile had driven away.

Another concern for vehicle charging may be the impact of a person or animal getting under the car and between the resonators while the car is charging. Even in situations having field levels below established safety levels, there may be consumer desire to reduce or eliminate the fields in that operating scenario.

Therefore a need exists for a wireless vehicle charger safety system that addresses such practical challenges to allow widespread use of wireless vehicle chargers in typical user environments.

### SUMMARY

A wireless vehicle charger includes subsystems to address safety concerns. A detection subsystem determines whether there is a safety issue.

In one aspect, a notification subsystem warns a user of the safety issue.

In another aspect a management subsystem addresses the safety issue.

In one specific aspect heat sensitive paint applied in an area of interest changes color to indicate high temperatures.

In still another aspect, the detection subsystem includes a sensor and communicates with the notification subsystem, which includes an indicator.

In yet another aspect, the management subsystem is configured to provide cooling. In a related aspect, the management system is configured to remove an overheated item. In a further related aspect, the management system is configured to alter operation of the vehicle charger in response to determining that there is a safety issue.

Those skilled in the art will recognize that a particular configuration addressed in this disclosure can be implemented in a variety of other ways. Unless otherwise defined, all technical and scientific terms used herein have the same meaning as commonly understood by one of ordinary skill in the art to which this disclosure belongs.

The features described above may be used alone or in combination without departing from the scope of this disclosure. Other features, objects, and advantages of the systems and methods disclosed herein will be apparent from the following detailed description and figures.

### BRIEF DESCRIPTION OF FIGURES

FIG. 1 is a side view of an automobile parked in a parking area equipped with a vehicle charging system and corresponding safety system.

FIG. 2(a) is an isometric view illustrating use of heat-sensitive paint over a vehicle charging system resonator, and FIG. 2(b) is an isometric view illustrating the shape of a source resonator enclosure.

FIG. 3 is a high-level block diagram of a vehicle charger safety system in accordance with an embodiment described herein.

FIG. 4(a) is an isometric view of an embodiment of a resonator with an array of temperature sensors and indicators, and FIG. 4(b) is an isometric view of an embodiment of a resonator with strip sensors for detecting heat.

### DETAILED DESCRIPTION

As described above, this disclosure relates to wireless vehicle chargers using coupled resonators. Extensive discussion of systems using such resonators is provided, for example, in commonly owned U.S. patent application Ser. No. 12/613,686 published on May 6, 2010 as US 2010010909445 and entitled “Wireless Energy Transfer Systems,” and incorporated herein by reference in its entirety as if fully set forth herein.

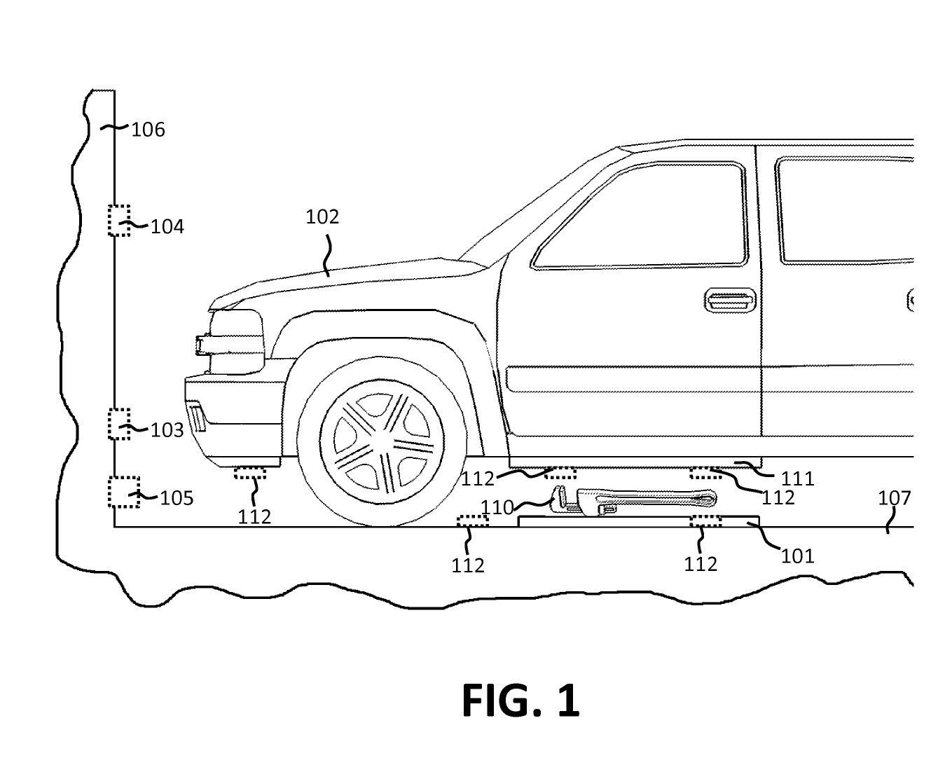

Referring now to FIG. 1, a charging source resonator 101 is integrated with a garage floor 107 so as to provide wireless charging to an automobile 102. In one embodiment, source resonator 101 is embedded in floor 107. In a second embodiment, resonator 101 is fixed on top of floor 107, such as by a plate bolted to floor 107. In a third embodiment, resonator 101 is implemented as a mat laid on top of floor 107. Resonator 101 is part of a wireless vehicle charging system, the other components of which are not explicitly illustrated here. For clarity in this disclosure, other components of the wireless charging system can be considered to be represented by resonator 101, even though such other components may actually be located remotely from resonator 101. A vehicle resonator 111 (sometimes referred to as a device, capture, drain or sink resonator) attached to automobile 102 captures the energy transferred via oscillating magnetic fields from source resonator 101. In one embodiment, device resonator 111 is attached to the underside of automobile 102 toward its midsection; in variations resonator 111 is located substantially toward the front or rear of automobile 102. In still other embodiments, resonator 111 is integrated into part of the structure, body or panels of automobile 102. As a specific example, resonator 111 may be shaped to fit into a vehicle's bumper section, allowing almost invisible design while being positioned within reasonably close proximity to either a wall- or floor-mounted source resonator 101. It should also be noted that where terms such as “charging” or “charger” are used herein they should be construed broadly to include generalized power transfer, as opposed to just battery charging.

In practice, it is found that in certain instances, extraneous objects (e.g., object 110) disposed between source resonator 101 and a corresponding vehicle resonator 111 can alter the operating characteristics of a vehicle charging system. Depending on the nature of object 110 and its location, object 110 can absorb some of the energy being transferred by the system, resulting in heating of the object 110 and its surroundings.

For systems capable of wirelessly recharging vehicles such as automobiles, the absorbed energy in object 110 can cause it and the surrounding area to become too hot to touch. For example, if automobile 102 leaves the charging area after hours of recharging, someone picking up object 110 could find it too hot to touch. Likewise, even if the object is moved, a person or animal standing on the heated area could be affected.

Accordingly, in one embodiment a sensor 103 detects thermal conditions significant enough to result in a safety concern. As shown in FIG. 1, sensor 103 is mounted on wall 106 in front of the automobile. In various implementations for such wall-mounted configurations, a conventional thermal sensor 103 such as an infrared camera or solid-state sensor is aimed from wall 106 to the area around resonator 101 and detects high temperatures anywhere in that area. In other implementations, a conventional heat sensor such as a thermistor-based sensor is integrated directly in resonator 101. In alternate implementations, an array of such sensors is used to provide coverage for a larger area of interest. In some embodiments, one or more thermal sensors 112 comprising IR cameras, temperature gauges, and the like are positioned around source resonator 101, integrated into source resonator 101, integrated into device resonator 111, or attached to automobile 102. In some applications mounting sensors 112 on the underside of automobile 102 may be preferable, as that location typically provides a clear view of the source resonator 101 below.

Some inexpensive implementations of sensor 103 such as unfocused infrared detectors may read vastly differently if their field of view includes areas that are being warmed due to other reasons, for instance sun beating down on floor 107 or engine/exhaust system heat. To allow continued use of very inexpensive devices for sensor 103, in such situations additional sensors are used to provide a level of calibration. In one embodiment, a sensor (not shown) is located above the automobile, for instance in the location of annunciator 104, and is aimed to obtain a reference ambient temperature not indicative of a resonator-related heat issue. The difference in temperatures is then used to determine whether there is an over-temperature situation related to charging of automobile 102. In other embodiments a light indicator rather than a heat indicator is used to determine whether sunlight falling on floor 107 is resulting in higher than expected temperature indications from sensor 103.

In some embodiments it may be possible to determine the source of a temperature increase by turning on and off the power transfer and examining temperature readings to see whether they correlate or follow the modulation of power transfer. For example, if the safety system suspects (e.g., due to a high sensor reading) there might be an object that is being heated due to the wireless power transfer, the safety system may temporaly modulate the level of wireless power transfer in a prescribed or random temporal fashion. If heating or a temperature increase detected by a sensor follows the modulation of the power source there may be a high likelyhood that the wireless power transfer is causing a heating effect of a foreign object.

In some embodiments, sensor(s) 112 calibrate the area around resonator 101 once a vehicle has parked but before charging is initiated. This calibration procedure provides a baseline value for subsequent sensing so that temperature changes attributable to charging are more easily identified for mitigation or notification, as detailed herein.

Depending on the nature of the safety concern, an appropriate response to a high temperature condition may vary. If a charging system is known to be prone to overheating only in one particular location (a known hot spot), it may be most appropriate to actively cool that location if heat above an acceptable threshold is detected. If the safety risk is one of only discomfort or minor injury, a warning to those nearby may be most appropriate. In certain embodiments, upon determining an unacceptable amount of heating the charging power level is reduced so that the vehicle is still charged, albeit at a slower rate. In such a situation, it may be appropriate for the system to notify the vehicle owner with an indicator (e.g., via a wireless communication protocol, email message, text message, cell phone message) of this reduced charging rate. The vehicle owner can then decide whether to return to the vehicle to clear the object 110 causing the reduction in charge rate.

Accordingly, in one embodiment an annunciator 104 is operatively coupled to the sensor(s) 103, 112 such that it activates upon sensor(s) 103, 112 detecting high temperatures. In one embodiment, annunciator 104 provides an auditory warning, such as a synthesized voice cautioning those nearby to be careful of high temperatures underneath the automobile. Alternatively, simpler notifications such as chirps, beeps and the like are used to warn those nearby. If more information should be conveyed, a sign near the annunciator is provided to explain that when it is activated, there are high temperatures in the area. In various environments, indicators other than such an annunciator 104 are more appropriate.

In some environments, the likelihood of high temperatures in the vicinity of resonator 101 causing a safety issue may be minimal when automobile 102 is still present, but increase markedly once automobile 102 departs, thereby leaving an open space into which pedestrians, or for instance a dog on a leash, might venture. In such environments, sensor(s) 103, 112 include an integrated proximity sensor that determines the presence or absence of automobile 102, and only activates annunciator 104 when both (i) a high temperature situation is detected and (ii) automobile 102 is no longer present.

As described above, annunciator 104 provides an aural warning. In other embodiments, visual warnings are provided. In simple implementations, the visual warnings are via solid or blinking lights, e.g., LED devices. In more complex implementations, electronic signs including text messages are provided. Depending on the environment and extent of the concern, pulsating, blinking or strobed lighting effects are used to provide the appropriate amount of attention to the risk. In some embodiments, a message is sent to the owner or other specified user via phone, text, tweet, email instant message or the like.

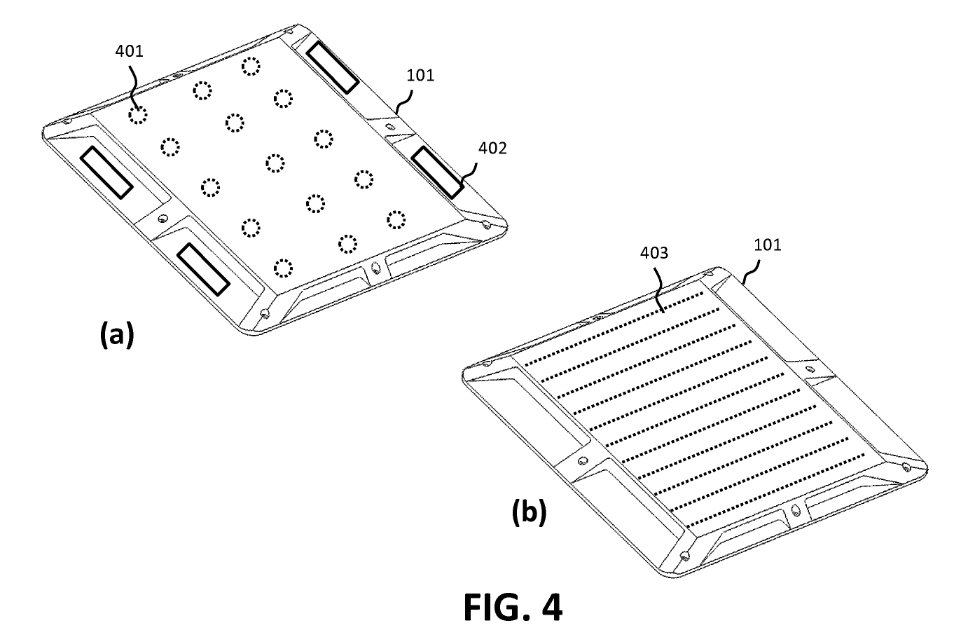

Referring now to FIG. 4(a), in various embodiments arrays or arrangements of temperature sensors are integrated into the enclosure of the source or device resonators. In one embodiment depicted in FIG. 4(a), temperature sensors 401 are deployed as an array on the top of resonator 101. The array of temperature sensors 401 may be mounted on the inside of the resonator enclosure close enough to the top surface of the resonator to detect temperature differences due to hot objects on top of the resonator. In other embodiments the temperature sensors 401 are integrated with the enclosure itself as encased within, or integral to, the packaging of the enclosure. In yet another embodiment the sensors 401 are in a separate module substantially covering the top of resonator 101. The array of temperature sensors 401 may be used and calibrated to distinguish between localized heating due to a lossy object placed on top of resonator 101 or due to overall rise in ambient temperature. For example, a higher temperature reading in one or two sensors may signify that a foreign object may be on top of the resonator and absorbing energy, whereas an overall rise in temperature readings of all the temperature sensors may signify changes in the ambient temperature due to the sun, environment, and the like. An ability to make such a differential reading can eliminate any need for calibration of the sensors, as only the relative difference between their readings may be needed to detect a hot object. In some applications, the output of the sensors 401 is coupled to the power and control circuitry of the source allowing the source control to change its operating parameters to limit or reduce the heating of the foreign object. Lights 402 on or near resonator 101 such as LEDs, photoluminescent strips, or other light emitting sources are optionally provided to alert a user of a potentially hot object, based on the output of sensors 401.

In an another embodiment, as depicted in FIG. 4(b), strips, wires, strings, and the like of heat sensitive material 403 are arranged across the face of the source resonator 101. The strips 403 are coupled to appropriate sensing circuitry to detect the changes in properties of the strips 403 due to heating from objects on top of the resonator and are used to control the power output or other operating characteristics of the resonator or notify the user of possible hot items on top of the resonator as described above.

In certain environments, a safety risk may be sufficiently large that a warning alone is inadequate. For instance, children might wander through a parking facility at a playground or school and try to pick up an object 110 that is hot. In such environments, active management of the overheating is appropriate. Accordingly, in the embodiment of FIG. 1, a coolant dispenser 105 is disposed on wall 106 near floor 107 and activates upon detection of overheating. In a simple embodiment, coolant dispenser 105 is merely a water nozzle with a solenoid-controlled valve that opens when overheating is detected. In a related embodiment, the water spray is used for additional purposes as well, including cleaning the underbody of the automobile (in one particular embodiment in combination with other car washing nozzles), cleaning oil, grease and other automotive fluids from floor 107, and sweeping debris from floor 107. Other environments may call for more complex approaches. In one embodiment, cooling tubes are integrated with resonator 101.

In certain environments, the safety concerns related to overheating call for reducing or turning off vehicle charging rather than, or in addition to, notification of an overheating condition or activation of a cooling mechanism. In one implementation for such environments, sensor 103 is coupled to the vehicle charger and an over-temperature indication results in fully or partially depowering the charger. In one embodiment, conventional interlock circuitry is used to implement such control so that charging cannot take place if object 110 is detected. Some vehicle charger designs make use of multiple source and device resonators; in such implementations one embodiment applies different combinations of resonator elements to permit some charging to continue, but in a manner that does not result in overheating. In some embodiments, the charging system includes a variable size source and the size of the source may be varied to permit at least some charging to continue, but in a manner that does not result in overheating. In other embodiments a wireless charging system includes multiple source and device resonators or an array of source and device resonators which may be energized or powered in a manner that minimizes heating of the foreign objects. For example, in one embodiment a wireless charging system may include one source and device resonator positioned toward the front of the automobile and a second source and device resonator positioned towards the rear of the automobile. Temperature sensors may monitor any abnormal conditions in between or around the source and device resonators and use the pair that produces the least amount of heating, allowing the automobile to receive power despite a possible obstruction.

Preventing overheating rather than reacting to overheating is preferable in certain environments. In such circumstances, sensor 103 detects the presence of an object 110 that may result in overheating and takes the appropriate action (notification, clearing the object, shutting down of the charger) before any overheating occurs. In such environments, sensor 103 is implemented not to detect overheating itself, but the mere presence of an object likely to lead to overheating. In a simple embodiment, light beams are used in a manner similar to garage door mechanisms to ensure the absence of humans or objects before closing the door. Conventional light curtains may provide a slightly more comprehensive detection area. In certain implementations, digital cameras and conventional machine vision systems are cost-effective components for sensor 103, particularly if other systems relating to the automobile or the vehicle charging system already employ such components for other purposes (e.g., assistance to a driver in parking so that resonators are aligned). Some vehicles already have systems that use transmitted and/or reflected acoustic, microwave, RF, optical, and other signals for positioning, parking assist, collision avoidance and the like; in appropriate environments minor modifications and enhancements to these systems may provide cost-effective supplements and alternatives to sensor 103. For example, an automobile with low-mounted LIDAR curb detection for parking assist is readily modified for the LIDAR to face toward the resonator area, rather than toward a curb, while in a charging mode. Sensor(s) 112 are also usable in some embodiments to detect presence of object 110 in the same manner as described above.

In various embodiments one or more pressure, temperature, capacitive, inductive, acoustic, infrared, ultraviolet, and the like sensors are integrated into the source, device, source housing, vehicle, or surrounding area to detect obstructions and foreign objects and/or materials between the source and device resonators. In critical environments the sensors and safety system constantly monitor the resonator area for movement, extraneous objects, and any type of undefined or abnormal operating condition. For example, a housing covering resonator 101 may include or may be mounted on top of a pressure sensor that monitors the weight or forces pushing on the enclosure of source resonator 101. Extra pressure or additional detected weight, for example, may indicate a foreign or unwanted object that is left on top of the source making it unsafe or undesirable to operate the charging system. Much like operation of sensor 103, output from such a pressure sensor is coupled to processing elements of the charging system and is used to stop or reduce wireless power transfer when the sensor is tripped or detects abnormalities. As appropriate for the particular environment the sensor is coupled to an auditory, visual, vibrational, communication link or other indicator to provide notification of charger interruption. In some embodiments multiple sensors, sensing multiple parameters, are used simultaneously to determine if an obstruction or a foreign object is present. To prevent false triggering, in some embodiments at least two sensors must be tripped, such as a pressure and a temperature sensor, for example, to turn off the vehicle charger.

In a resonator implementation in which metal is the most likely substance to lead to overheating, one embodiment integrates sensor 103 via a metal detector. An advantage of such an implementation is that conventional metal detector circuitry is based on inductive loops, which can be easily integrated with typical designs of resonators (e.g., 101). Given the large mass of metal in automobile 102, preferably such detector has an effective range shorter than the distance to automobile 102. A variety of conventional magnetometer architectures are usable to sense presence of an object 110. The frequency of operation and type of magnetometer are preferably chosen for reliable operation in the presence of a large charging field; alternatively, such magnetometer is used before the charger is turned on, when it is at reduced power, or when it has been turned off, such as during temporary interruptions in charging to allow a magnetometer check.

In some resonator implementations, presence of an object 110 likely to cause overheating may result in an operating parameter of the resonator to vary from what would be expected. For example, the power transfer from the charger may be noticeably reduced, the amplitude of an expected voltage or current may change, a magnetic field may be altered, a reactance value of the resonator may change, and a phase relationship in vehicle charger may change from what would be expected. Depending on the particular implementation of resonators and other circuitry in the vehicle charger, an appropriate electrical parameter or set of parameters is compared with a nominal value and such comparison is used rather than, or in combination with, sensor 103 to detect presence of object 110. In some resonator implementations the system may monitor the power input at the source as well as received power at the device resonator and compare that value to an expected or nominal value. Significant differences from a nominal value may mean that the energy is being dissipated in other objects or there may be an error in the system. In some resonator implementation the coupling factor k, the quality factor Q, the resonant frequency, inductance, impedance, resistance, and the like may be measured by the system and compared to nominal or expected values. A change of 5% or more of the parameters from their nominal values may signify an error in the system, or a foreign object and may be used as a signal to shutdown, lower the power transfer, run diagnostics, and the like. For example, high-conductivity materials may shift the resonant frequency of a resonator and detune it from other resonant objects. In some embodiments, a resonator feedback mechanism is employed that corrects its frequency by changing a reactive element (e.g., an inductive element or capacitive element). To the extent that such mechanisms are already present in a vehicle charger system, in certain embodiments they are employed to supplement and in certain environments replace sensor 103.

Discussion above has primarily focused on detection and response based on components that are part of the vehicle charger. In certain embodiments, portions of such circuitry are instead deployed at least in part on automobile 102 itself. For instance, line of sight from sensor 103 mounted on wall 106 may be inferior to that achievable by a sensor or array of sensors mounted on the underside of automobile 102. Other advantages flow from such automobile-mounted implementations as well. Sensors can easily be aimed directly below the automobile's device resonator and can be positioned so as to avoid sensing artifact-producing locations such as near exhaust system components, engine components, brake components and the like. In one such embodiment, annunciator 104 is also implemented in automobile 102. In one specific example, the existing voice synthesis module used for the automobile's GPS system is used to announce to the driver that charging will not occur because an object 110 is detected beneath the vehicle, and that it should be cleared so that charging can commence.

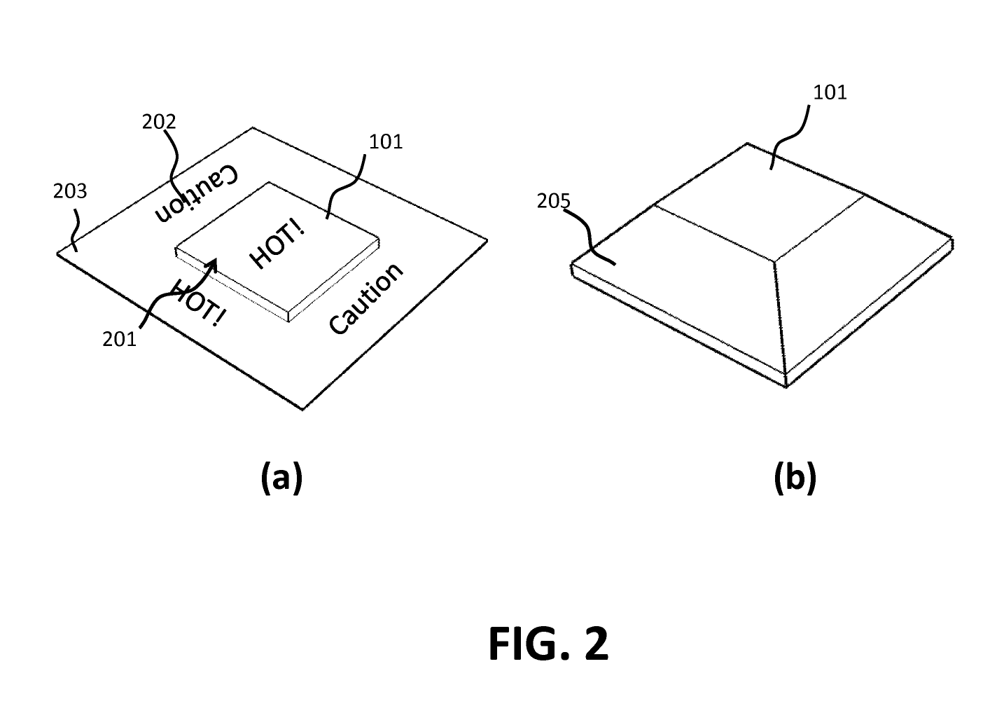

Referring now to FIG. 2(a), an alternate embodiment that does not require any circuitry is based on the use of thermally sensitive materials. In one specific embodiment, resonator 101 is deployed with heat sensitive paint applied in an area 201 overlapping resonator 101 and in an adjacent area 203 such that if an object becomes sufficiently warm, a portion of the area affected by the heated object will change color to warn of high temperatures. Preferably, a distinctive color change that provides a clear warning is used, such as from white to neon red/orange. In one embodiment, the paint is applied through stencils such that a warning message 202 (e.g., “HOT” of “Caution”) appears when the paint changes color.

By using heat sensitive paint, the functions of both sensor 103 and annunciator 104 are achieved together. Management functions can also be achieved in a “passive” manner that does not call for components such as solenoid-controlled water valve/nozzle arrangements (e.g., 105). In one such embodiment, depicted in FIG. 2(b), a portion of resonator 101 is not merely flat, but is implemented in a pyramidal, crowned or conical shape 205 such that an object 110 is not likely to stay on resonator 101. In a first implementation, such shape is achieved by using a conventional form for the poured concrete, epoxy, Fiberglas or other material that makes up the remainder of the surface of floor 107. In certain environments, low loss materials such as Teflon, REXOLITE, styrene, ABS, delryn, and the like are preferable for implementing area 201 over resonator 101 to provide both strength and minimal interaction with the charging fields. In a second implementation, a mat including resonator 101 and having a pyramidal shape is used to implement area 201. In this implementation, the material of the mat itself rather than heat sensitive paint may change color with heat. In a related embodiment a thermotropic material is used for the mat such that heated areas of the mat rise to form a slope wherever a hot object is, gradually causing it to migrate off of the energized area. Numerous thermotropic materials are known that change in appearance with temperature and can thus provide visual indication of overheating as well. An alternate embodiment achieves deformation by including a bladder in the mat such that by filling the bladder with air, water or another substance the shape of the mat changes to dislodge foreign objects (e.g., 110). In yet another implementation, area 201 is implemented as a wobbly surface, such as a pyramidal surface suspended at its apex from the floor by a short cylinder. By such suspension, the perimeter of such surface is nominally maintained a short height (in one embodiment approximately 1 cm) above floor 107 such that when a vehicle or pedestrian walks over the surface, it moves sufficiently that an object 110 is likely to eventually roll or slide off. Optionally, a drain area is integrated around the periphery of area 201 or 203 so that melting snow and other debris readily migrate into the drain. In environments where greater certainty of object clearance is required, the supporting cylinder mentioned above is part of a piston subsystem that controllably provides vibration to the surface to move objects off of resonator 101. In some charger implementations, resonator 101 is designed to be movable so as to optimally align with a corresponding resonator in automobile 102. In those implementations, the same mechanism used to achieve resonator alignment is used to move/vibrate the surface so as to relocate object 110 from area 201.

An alternative for clearing area 201 of extraneous objects is a conventional sweeper/wiper mechanism (not shown) deployed from wall 106 or another convenient location. In one embodiment, the clearing mechanism operates immediately as a vehicle approaches area 201 to minimize the likelihood that tools, trash or other materials get placed in area 201 between the time of clearing and the time that charging begins. In some embodiments, this mechanism is engaged by operation of an automatic garage door opener; in other embodiments a conventional remote control is used. In an alternate embodiment, the clearing mechanism is capable of operation even when automobile 102 is parked over area 201 so that materials such as melting ice from automobile 102 can be cleared while vehicle charging is taking place. This is important because it is found that winter slush sometimes includes extraneous materials such as metal debris (e.g., from broken snowplow bolts, salt spreading apparatus and the like). Once the slush melts, the resulting debris can cause the same high temperature conditions as described above. As ferrous objects are found to be particularly susceptible to heating, in one embodiment a magnetized wiper mechanism is used to more readily clear metal objects.

In environments in which slush is considered particularly problematic, water jets aimed at the underbody of the automobile dislodge slush quickly before charging commences. A particular advantage of such jets is that if sufficient water is used, the water dripping from the underbody onto area 201 will eventually cause not only slush, but at least small objects as well, to be dislodged from area 201.

A related embodiment using water jets is well suited for warmer environments. This embodiment provides a relatively strong blast of water from above area 201 just before the automobile arrives, thus clearing area 201 of foreign material. An advantage of such an approach is that it is readily integrable with other features of interest, such as a car rinse or car wash.

Not all vehicle charger resonators are deployed underneath an automobile. In some applications, resonators are implemented in other structures. In one alternative implementation, source resonators are implemented as horizontal barriers suspended from wall 106 at a height set to match a corresponding resonator in the front or rear bumper of automobile 102. In another implementation, vertical posts set in floor 107, such as those commonly provided for protection of a wall or support column in a parking garage, serve as enclosures for source resonator 101. Such varied implementations result in possible safety issues that differ somewhat from the examples discussed herein. However, those skilled in the art will recognize that the principles disclosed herein can readily be applied to other implementations as well.

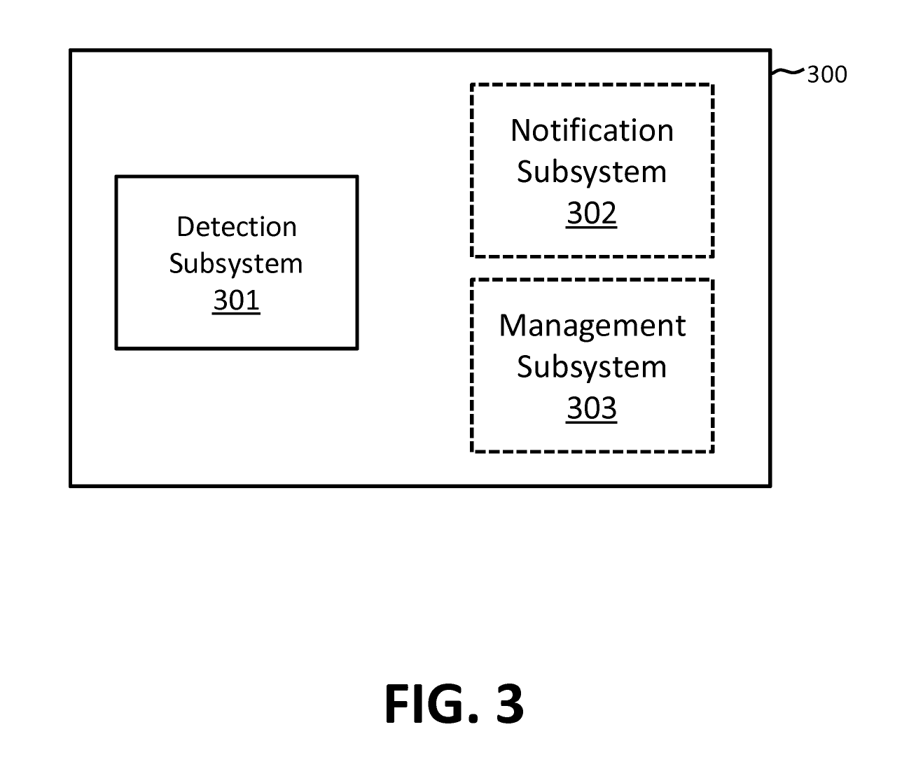

Referring now to FIG. 3, a wireless vehicle charger safety system 300 includes a detection subsystem 301, a notification subsystem 302, and a management subsystem 303. In certain environments, the notification and management subsystems are not required. In other embodiments, the various subsystems are implemented in an integrated manner; the use of heat-sensitive paint as discussed in connection with FIG. 2(a) is an example in which the detection subsystem and the notification subsystem are implemented in a unitary manner. Not shown in FIG. 3 are various interconnections that exist in certain embodiments with other components of a wireless vehicle charger, such as interlock circuitry that is controllable by the management subsystem. As shown in this disclosure, the various subsystems are implemented in different embodiments by electronic circuitry, electro-mechanical systems, chemical/materials-based approaches, fluid control systems, computer-implemented control systems, and the like. In practice it is found that one particular application environment may be ill-suited for an approach that is optimal in a different application environment. Large trucks kept in a company loading facility call for different safety measures than passenger cars in a residential garage. In some embodiments, subsystems 301-303 operate with self-learning or trainable algorithms designed to function in or with a wide variety of environments, vehicles, sources, and systems and may learn or be trained to operate in many environments after periods of supervised operation. In some embodiments, any or any combination of the detection subsystem 301, a notification subsystem 302, and a management subsystem 303, may be a stand alone module or subsystem. In other embodiments, any or any combination of the detection subsystem 301, a notification subsystem 302, and a management subsystem 303, may be implemented at least partially using resources already available on the vehicle.

While the invention has been described in connection with certain preferred embodiments, other embodiments will be understood by one of ordinary skill in the art and are intended to fall within the scope of this disclosure, which is to be interpreted in the broadest sense allowable by law.

All documents referenced herein are hereby incorporated by reference in their entirety as if fully set forth herein.

What is claimed is:

1. A safety system for a charger to provide protection with respect to an object that may become hot during operation of the charger, the safety system comprising:
a detection subsystem configured to detect presence of the object in substantial proximity to the charger; and
a notification subsystem operatively coupled to the detection subsystem and configured to provide an indication of the object.

2. A safety system as in claim 1, further comprising a management subsystem operatively coupled to the detection subsystem and configured to mitigate an effect of the object.

3. A safety system as in claim 1, wherein the detection subsystem includes a heat sensor.

4. A safety system as in claim 1, wherein the notification subsystem includes an annunciator.

5. A safety system as in claim 1, wherein the detection subsystem comprises heat sensitive paint.

6. A safety system as in claim 1, wherein the notification subsystem comprises heat sensitive paint.

7. A safety system as in claim 2, wherein the management subsystem is configured to cool an area associated with the object.

8. A safety system as in claim 2, wherein the management subsystem is configured to move the object.

9. A safety system as in claim 2, wherein the management subsystem is configured to alter operation of the charger responsive to detection of the object.

10. A safety system as in claim 1, wherein the charger includes a source resonator, wherein the detection subsystem is integrated with the source resonator.

11. A safety system as in claim 1, wherein the charger includes a source resonator, wherein the notification subsystem is integrated with the source resonator.

12. A safety system as in claim 2, wherein the charger includes a source resonator, wherein the management subsystem is integrated with the source resonator.

13. A safety system as in claim 1, wherein the detection subsystem includes a wall-mounted sensor.

14. A safety system as in claim 1, wherein the detection subsystem includes a light sensor.

15. A safety system as in claim 1, wherein the detection subsystem includes a camera.

16. A safety system as in claim 1, wherein the detection subsystem includes a sensor mounted on a vehicle.

17. A safety system as in claim 1, wherein the detection subsystem includes a sensor integrated with a device resonator of a vehicle.

18. A safety system as in claim 1, wherein the detection subsystem includes an ambient sensor not significantly responsive to whether the object is hot, the detection subsystem configured to use output from the ambient sensor for calibration.

19. A safety system as in claim 1, configured to use the detection system for baseline calibration before the charger commences charging.

20. A safety system as in claim 1, wherein the notification subsystem includes an annunciator configured to provide a warning signal in an area proximate to the object.

21. A safety system as in claim 20, wherein the warning signal is a visual indication.

22. A safety system as in claim 20, wherein the warning signal is an aural indication.

23. A safety system as in claim 1, wherein the notification subsystem is configured to provide a remote notification of the object.

24. A safety system as in claim 23, wherein the remote notification includes an electronically delivered message.

25. A safety system as in claim 1, wherein the notification subsystem is enabled upon movement of a vehicle away from the object.

26. A safety system as in claim 1, wherein the notification subsystem comprises a plurality of sensors, the notification subsystem being configured to detect presence of the object responsive to differential temperature indications from a subset of the plurality of sensors.

27. A safety system as in claim 2, wherein the management subsystem includes a coolant dispenser configured to supply a coolant to an area associated with the object responsive to detection of the object.

28. A safety system as in claim 27, wherein the coolant dispenser is further configured to provide movement of debris.

29. A safety system as in claim 27, wherein the coolant dispenser is further configured to move the object.

30. A safety system as in claim 27, wherein the coolant dispenser is integrated with a source resonator of the charger.

31. A safety system as in claim 2, wherein the management subsystem is configured to turn off the charger responsive to detection of the object.

32. A safety system as in claim 2, wherein the management subsystem is configured to reduce a charging level of the charger responsive to detection of the object.

33. A safety system as in claim 2, wherein the management subsystem is configured to change an operational parameter of the charger responsive to detection of the object.

34. A safety system as in claim 33, wherein the operational parameter relates to selection of a subset of plural resonators.

35. A safety system as in claim 1, wherein the detection subsystem is integrated with a vehicle's electronic systems.

36. A safety system as in claim 1, wherein the notification subsystem is integrated with a vehicle's electronic systems.

37. A safety system as in claim 2, wherein the management subsystem is integrated with a vehicle's electronic systems.

38. A safety system as in claim 1, wherein the detection subsystem includes a magnetometer.

39. A safety system as in claim 1, wherein the detection subsystem includes a magnetometer integrated with a resonator.

40. A safety system as in claim 1, wherein the detection subsystem is coupled with a charging subsystem of the charger, the detection subsystem taking as input operational parameters of the charging subsystem and determining presence of the object based on the operational parameters of the charging subsystem.

41. A safety system as in claim 2, wherein the management subsystem includes a surface configured to facilitate movement of the object.

42. A safety system as in claim 2, wherein the management subsystem includes a surface that moves so as to facilitate movement of the object.

43. A safety system as in claim 2, wherein the management subsystem includes a mechanism to sweep the object so as to cause it to move.

44. A safety system as in claim 2, wherein the management subsystem includes a mechanism to facilitate movement of the object using magnetism.

45. A safety system as in claim 2, wherein the management subsystem includes a drain configured for fluid handling proximate to the object.

46. A safety system as in claim 1, wherein the detection subsystem and the notification subsystem are integrated.

47. A safety system as in claim 2, wherein the detection subsystem and the management subsystem are integrated.

48. A safety system as in claim 2, wherein the notification system and the management subsystem are integrated.

49. A method to ensure safe operation of a charger with respect to an object that may become hot during operation of the charger, the method comprising:
detecting presence of the object; and
providing notification of the presence of the object.

50. The method of claim 49, further comprising taking a management action responsive to detecting presence of the object.

51. The method of claim 49, wherein said detecting includes sensing heat associated with the object.

52. The method of claim 49, wherein said providing notification includes triggering a local indicator.

53. The method of claim 49, wherein said providing notification includes triggering a message to a remote location.

54. The method of claim 50, wherein said taking a management action includes cooling an area proximate to the object.

55. The method of claim 50, wherein said taking a management action includes moving the object.

56. The method of claim 50, wherein said taking a management action includes changing a mode of operation of the charger.
